(19) United States
(12) Patent Application Publication
(10) Pub. No.: US 2018/0036696 A1
(43) Pub. Date: Feb. 8, 2018

(54) SUPERHARD CONSTRUCTIONS AND METHODS OF MAKING SAME

(71) Applicant: Element Six (UK) Limited, Oxfordshire (GB)

(72) Inventors: Nedret CAN, Oxfordshire (GB); Sedigheh SALEHI, Oxfordshire (GB)

(73) Assignee: Element Six (UK) Limited, Oxfordshire (GB)

(21) Appl. No.: 15/553,667

(22) PCT Filed: Feb. 26, 2016
(86) PCT No.: PCT/EP2016/054160

§ 371 Date: Aug. 25, 2017

(30) Foreign Application Priority Data
Feb. 28, 2015 (GB) 1503444.0
Jul. 15, 2015 (GB) 1512331.8

(51) Int. Cl. B01J 3/06; E21B 10/573; C04B 35/645; C04B 37/02; C04B 35/5831; B32B 18/00; C04B 35/528

(52) U.S. Cl. CPC B01J 3/062; B32B 18/00; E21B 10/5735; C04B 35/528; C04B 37/026; C04B 35/5831; C04B 37/025; C04B 35/645; B01J 2203/0685; B01J 2203/0655; B01J 2203/062; C04B 2237/361; C04B 2235/5436; C04B 2237/401; C04B 2237/363; C04B 2237/122; C04B 2237/708

(57) ABSTRACT

A superhard polycrystalline construction (30) comprises a first region (34) comprising a body of thermally stable polycrystalline superhard material having an exposed surface forming a working surface (4), and a peripheral side edge (6), a second region (32) forming a substrate to the first region, and a third region (36) at least partially interposed between the first and second regions wherein the third region comprises a material more acid resistant than polycrystalline diamond material having a binder-catalyst phase comprising cobalt, and/or more acid resistant than cemented carbide material.

### FIELD

This disclosure relates to superhard constructions and methods of making such constructions, particularly but not exclusively to constructions comprising polycrystalline diamond (PCD) structures attached to a substrate, and tools comprising the same, particularly but not exclusively for use in rock degradation or drilling, or for boring into the earth.

### BACKGROUND

Polycrystalline superhard materials, such as polycrystalline diamond (PCD) and polycrystalline cubic boron nitride (PCBN) may be used in a wide variety of tools for cutting, machining, drilling or degrading hard or abrasive materials such as rock, metal, ceramics, composites and wood-containing materials. In particular, tool inserts in the form of cutting elements comprising PCD material are widely used in drill bits for boring into the earth to extract oil or gas. The working life of super hard tool inserts may be limited by fracture of the super hard material, including by spalling and chipping, or by wear of the tool insert.

Cutting elements such as those for use in rock drill bits or other cutting tools typically have a body in the form of a substrate which has an interface end/surface and a super hard material which forms a cutting layer bonded to the interface surface of the substrate by, for example, a sintering process. The substrate is generally formed of a tungsten carbide-cobalt alloy, sometimes referred to as cemented tungsten carbide and the super hard material layer is typically polycrystalline diamond (PCD), polycrystalline cubic boron nitride (PCBN) or a thermally stable product TSP material such as thermally stable polycrystalline diamond.

Polycrystalline diamond (PCD) is an example of a superhard material (also called a superabrasive material or ultra hard material) comprising a mass of substantially inter-grown diamond grains, forming a skeletal mass defining interstices between the diamond grains. PCD material typically comprises at least about 80 volume % of diamond and is conventionally made by subjecting an aggregated mass of diamond grains to an ultra-high pressure of greater than about 5 GPa, and temperature of at least about 1,200° C., for example. A material wholly or partly filling the interstices may be referred to as filler or binder material.

PCD is typically formed in the presence of a sintering aid such as cobalt, which promotes the inter-growth of diamond grains. Suitable sintering aids for PCD are also commonly referred to as a solvent-catalyst material for diamond, owing to their function of dissolving, to some extent, the diamond and catalysing its re-precipitation. A solvent-catalyst for diamond is understood be a material that is capable of promoting the growth of diamond or the direct diamond-to-diamond inter-growth between diamond grains at a pressure and temperature condition at which diamond is thermodynamically stable. Consequently the interstices within the sintered PCD product may be wholly or partially filled with residual solvent-catalyst material. Most typically, PCD is often formed on a cobalt-cemented tungsten carbide substrate, which provides a source of cobalt solvent-catalyst for the PCD. Materials that do not promote substantial coherent intergrowth between the diamond grains may themselves form strong bonds with diamond grains, but are not suitable solvent-catalysts for PCD sintering.

Cemented tungsten carbide which may be used to form a suitable substrate is formed from carbide particles being dispersed in a cobalt matrix by mixing tungsten carbide particles/grains and cobalt together then heating to solidify. To form the cutting element with a superhard material layer such as PCD or PCBN, diamond particles or grains or CBN grains are placed adjacent the cemented tungsten carbide body in a refractory metal enclosure such as a niobium enclosure and are subjected to high pressure and high temperature so that inter-grain bonding between the diamond grains or CBN grains occurs, forming a polycrystalline superhard diamond or polycrystalline CBN layer.

In some instances, the substrate may be fully cured prior to attachment to the superhard material layer whereas in other cases, the substrate may be green, that is, not fully cured. In the latter case, the substrate may fully cure during the HTHP sintering process. The substrate may be in powder form and may solidify during the sintering process used to sinter the superhard material layer.

Ever increasing drives for improved productivity in the earth boring field place ever increasing demands on the materials used for cutting rock. Specifically, PCD materials with improved abrasion and impact resistance are required to achieve faster cut rates and longer tool life.

Cutting elements or tool inserts comprising PCD material are widely used in drill bits for boring into the earth in the oil and gas drilling industry. Rock drilling and other operations require high abrasion resistance and impact resistance. One of the factors limiting the success of the polycrystalline diamond (PCD) abrasive cutters is the generation of heat due to friction between the PCD and the work material. This heat causes the thermal degradation of the diamond layer. The thermal degradation increases the wear rate of the cutter through increased cracking and spalling of the PCD layer as well as back conversion of the diamond to graphite causing increased abrasive wear.

Methods used to improve the abrasion resistance of a PCD composite often result in a decrease in impact resistance of the composite.

The most wear resistant grades of PCD and PCBN used in cutters usually fail by spalling resulting in a catastrophic fracture of the cutter before it has worn out. Spelling is considered to be caused by a crack propagating from working area to the top free surface of the cutting tool. During the use of these cutters, cracks grow until they reach a critical length at which catastrophic failure occurs, namely, when a large portion of the PCD or PCBN breaks away in a brittle manner. Catastrophic failure of a component or structure indicates that crack grew to reach the “critical crack length” of the given structural material. The “critical crack length” is the acceptable length of crack beyond which the propagation of the crack becomes uncontrollable leading to catastrophic failure independently of the remaining non-working area of the component. The long, fast growing cracks encountered during use of conventionally sintered PCD and PCBN can therefore result in shorter tool life.

Furthermore, despite their high strength, polycrystalline diamond (PCD) and PCBN materials are usually susceptible to impact fracture due to their low fracture toughness. Improving fracture toughness without adversely affecting the material's high strength and abrasion resistance is a challenging task.

There is therefore a need for a superhard composite that has good or improved abrasion, fracture and impact resistance and a method of forming such composites.

### SUMMARY

Viewed from a first aspect there is provided a superhard polycrystalline construction comprising:

a first region comprising a body of thermally stable polycrystalline superhard material having an exposed surface forming a working surface, and a peripheral side edge;

a second region forming a substrate to the first region; and

a third region at least partially interposed between the first and second regions; wherein:

the third region comprises a material more acid resistant than polycrystalline diamond material having a binder-catalyst phase comprising cobalt, and/or more acid resistant than cemented carbide material.

In some examples, the third region may extend to and form part of the working surface.

Viewed from a further aspect there is provided a superhard polycrystalline construction having an exposed working surface comprising:
a first region comprising a body of thermally stable polycrystalline superhard material having a free external surface forming a portion of the working surface;
a second region forming a substrate to the first region; and
a third region at least partially interposed between the first and second regions; wherein:
the third region comprises a ceramic material having a fracture toughness of between around 4 MPa√m to around 15 MPa√m, the third region extending to and forming a further portion of the working surface.

Viewed from a further aspect there is provided a tool comprising the superhard polycrystalline construction defined above, the tool being for cutting, milling, grinding, drilling, earth boring, rock drilling or other abrasive applications.

The tool may comprise, for example, a drill bit for earth boring or rock drilling, a rotary fixed-cutter bit for use in the oil and gas drilling industry, or a rolling cone drill bit, a hole opening tool, an expandable tool, a reamer or other earth boring tools.

Viewed from another aspect there is provided a drill bit or a cutter or a component therefor comprising the superhard polycrystalline construction defined above.

### BRIEF DESCRIPTION OF THE DRAWINGS

Various versions will now be described by way of example and with reference to the accompanying drawings in which:

FIG. 1 is a perspective view of an example of a PCD cutter element or construction for a drill bit for boring into the earth;

FIG. 2 is a schematic cross-section of a conventional portion of a PCD micro-structure with interstices between the inter-bonded diamond grains filled with a non-diamond phase material;

FIG. 3 is a schematic cross-section of a first example of a superhard construction;

FIG. 4 is a schematic cross-section of a second example of a superhard construction;

FIG. 5 is a schematic cross-section of a third example of a superhard construction;

FIG. 6 is a schematic plan view of the superhard construction of FIG. 5;

FIG. 7 is a schematic cross-section of a fourth example of a superhard construction;

FIG. 8 is a schematic plan view of the superhard construction of FIG. 7;

FIG. 9 is a is a schematic alternative plan view of the superhard construction of FIG. 5;

FIG. 10 is a schematic cross-section of a fifth example of a superhard construction;

FIG. 11 is a schematic cross-section of a sixth example of a superhard construction;

FIG. 12 is a schematic cross-section of a sequence of steps for forming the superhard construction of FIG. 10;

FIG. 13 is a schematic cross-section of a seventh example of a superhard construction; and

FIG. 14 is a schematic cross-section of an eighth example of a superhard construction.

The same references refer to the same general features in all the drawings.

### DESCRIPTION

As used herein, a “superhard material” is a material having a Vickers hardness of at least about 28 GPa. Diamond and cubic boron nitride (cBN) material are examples of superhard materials.

As used herein, a “superhard construction” means a construction comprising a body of polycrystalline superhard material. In such a construction, a substrate may be attached thereto.

As used herein, polycrystalline diamond (PCD) is a type of polycrystalline superhard (PCS) material comprising a mass of diamond grains, a substantial portion of which are directly inter-bonded with each other and in which the content of diamond is at least about 80 volume percent of the material. In one example of PCD material, interstices between the diamond grains may be at least partly filled with a binder material comprising a catalyst for diamond. As used herein, “interstices” or “interstitial regions” are regions between the diamond grains of PCD material. In examples of PCD material, interstices or interstitial regions may be substantially or partially filled with a material other than diamond, or they may be substantially empty. PCD material may comprise at least a region from which catalyst material has been removed from the interstices, leaving interstitial voids between the diamond grains.

A “catalyst material” for a superhard material is capable of promoting the growth or sintering of the superhard material.

The term “substrate” as used herein means any substrate over which the superhard material layer is formed. For example, a “substrate” as used herein may be a transition layer formed over another substrate.

As used herein, the term “integrally formed” means regions or parts are produced contiguous with each other and are not separated by a different kind of material.

As used herein, the term “refractory metal” is to be understood to include those elements which have a melting point above 2,123 K (1,850° C.), for example niobium, molybdenum, tantalum, tungsten, rhenium, titanium, vanadium, chromium, zirconium, hafnium, ruthenium, osmium and iridium.

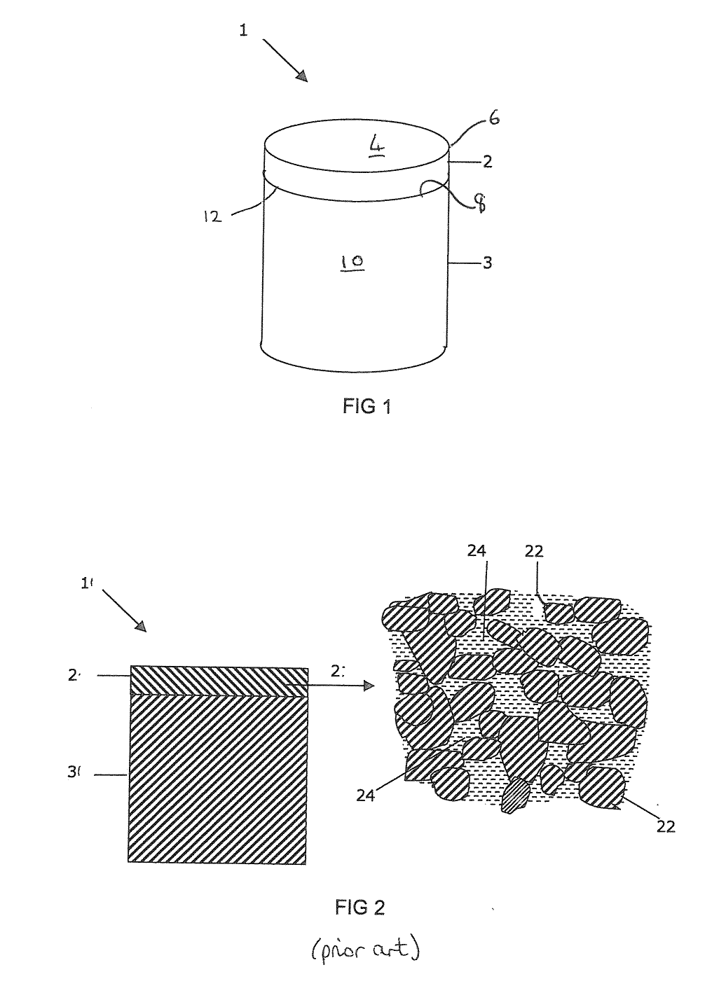

FIG. 1 is a schematic view of an example of a PCD superhard construction such as a cutting element 1 which includes a substrate 3 with a layer of superhard material 2 formed on the substrate 3. The substrate 3 may be formed of a hard material such as cemented tungsten carbide. The superhard material 2 may be, for example, high density polycrystalline diamond (PCD) comprising at least 95 vol % diamond. The cutting element 1 may be mounted into a bit body such as a drag bit body (not shown) and may be suitable, for example, for use as a cutter insert for a drill bit for boring into the earth.

The exposed top surface of the superhard material opposite the substrate forms the cutting face 4, also known as the working surface, which is the surface which, along with its edge 6, performs the cutting in use.

At one end of the substrate 3 is an interface surface 8. As shown in FIG. 1, the substrate 3 is generally cylindrical and has a peripheral surface 10 and a peripheral top edge 12.

The super hard material may be, for example, polycrystalline diamond (PCD) and the super hard particles or grains may be of natural and/or synthetic origin.

The substrate 3 may be formed of a hard material such as a cemented carbide material and may be, for example, cemented tungsten carbide, cemented tantalum carbide, cemented titanium carbide, cemented molybdenum carbide or mixtures thereof. The binder metal for such carbides suitable for forming the substrate 3 may be, for example, nickel, cobalt, iron or an alloy containing one or more of these metals. Typically, this binder will be present in an amount of 10 to 20 mass %, but this may be as low as 6 mass % or less. Some of the binder metal may infiltrate the body of polycrystalline super hard material 2 during formation of the compact 1.

In some examples, the body of polycrystalline super hard material 2 may be a high density PCD formed of more than 95 vol. % of diamond. Such a PCD body may be formed using known methods such as by sintering the diamond grains with binder catalyst at sintering pressures of around 8 GPa and above, as described in US patent application published as US 2010/0084196.

In some examples, the body of polycrystalline super hard material 2 may be formed of high density PCD comprising a sintered mass of nano diamond grains with a binder catalyst as set out in US patent application published as US2005/019114.

In some examples, high density or binderless PcBN, and PcBN constructions formed from nanomaterials may also be formed according to known methods.

In some examples of PCD material, interstices between the diamond grains may be at least partly filled with a binder material comprising a catalyst for diamond. As used herein, “interstices” or “interstitial regions” are regions between the diamond grains of PCD material. In examples of PCD material, interstices or interstitial regions may be substantially or partially filled with a material other than diamond, or they may be substantially empty. The PCD material may comprise at least a region from which catalyst material has been removed from the interstices, leaving interstitial voids between the diamond grains.

The polycrystalline composite construction 1 when used as a cutting element may be mounted in use in a bit body, such as a drag bit body (not shown).

The working surface or “rake face” 4 of the polycrystalline composite construction 1 is the surface or surfaces over which the chips of material being cut flow when the cutter is used to cut material from a body, the rake face 4 directing the flow of newly formed chips. This face 4 is commonly also referred to as the top face or working surface of the cutting element as the working surface 4 is the surface which, along with its edge 6, is intended to perform the cutting of a body in use. It is understood that the term “cutting edge”, as used herein, refers to the actual cutting edge, defined functionally as above, at any particular stage or at more than one stage of the cutter wear progression up to failure of the cutter, including but not limited to the cutter in a substantially unworn or unused state.

As used herein, “chips” are the pieces of a body removed from the work surface of the body being cut by the polycrystalline composite construction 1 in use.

As used herein, a “wear scar” is a surface of a cutter formed in use by the removal of a volume of cutter material due to wear of the cutter. A flank face may comprise a wear scar. As a cutter wears in use, material may progressively be removed from proximate the cutting edge, thereby continually redefining the position and shape of the cutting edge, rake face and flank as the wear scar forms.

The cemented metal carbide substrate may be conventional in composition and, thus, may be include any of the Group IVB, VB, or VIB metals, which are pressed and sintered in the presence of a binder of cobalt, nickel or iron, or alloys thereof. In some examples, the metal carbide is tungsten carbide.

The layer of superhard material 2 may also comprise PCBN. Components comprising PCBN are used principally for machining metals. PCBN material comprises a sintered mass of cubic boron nitride (cBN) grains. The cBN content of PCBN materials may be at least about 40 volume %. When the cBN content in the PCBN is at least about 70 volume % there may be substantial direct contact among the cBN grains. When the cBN content is in the range from about 40 volume % to about 60 volume % of the compact, then the extent of direct contact among the cBN grains is limited. PCBN may be made by subjecting a mass of cBN particles together with a powdered matrix phase, to a temperature and pressure at which the cBN is thermodynamically more stable than the hexagonal form of boron nitride, hBN. PCBN is less wear resistant than PCD which may make it suitable for different applications to that of PCD.

As used herein, a PCD or PCBN grade is a PCD or PCBN material characterised in terms of the volume content and size of diamond grains in the case of PCD or cBN grains in the case of PCBN, the volume content of interstitial regions between the grains, and composition of material that may be present within the interstitial regions. A grade of superhard material may be made by a process including providing an aggregate mass of superhard grains having a size distribution suitable for the grade, optionally introducing catalyst material or additive material into the aggregate mass, and subjecting the aggregated mass in the presence of a source of catalyst material for the superhard material to a pressure and temperature at which the superhard grains are more thermodynamically stable than graphite (in the case of diamond) or hBN (in the case of CBN), and at which the catalyst material is molten. Under these conditions, molten catalyst material may infiltrate from the source into the aggregated mass and is likely to promote direct intergrowth between the diamond grains in a process of sintering, to form a polycrystalline superhard structure. The aggregate mass may comprise loose superhard grains or superhard grains held together by a binder material. In the context of diamond, the diamond grains may be natural or synthesised diamond grains.

Different grades of superhard material such as polycrystalline diamond may have different microstructures and different mechanical properties, such as elastic (or Young's) modulus E, modulus of elasticity, transverse rupture strength (TRS), toughness (such as so-called K₁C toughness), hardness, density and coefficient of thermal expansion (CTE). Different PCD grades may also perform differently in use. For example, the wear rate and fracture resistance of different PCD grades may be different.

In the context of PCD, the PCD grades may comprise interstitial regions filled with material comprising cobalt metal, which is an example of catalyst material for diamond.

The polycrystalline superhard structure 2 shown in the cutter element of FIG. 1 may comprise, for example, one or more PCD grades.

As shown in FIG. 2, during formation of a conventional polycrystalline composite construction 1, the interstices 24 between the grains 22 of super hard material such as diamond grains in the case of PCD, may be at least partly filled with a non-super hard phase material. This non-super hard phase material, also known as a filler material may comprise residual catalyst/binder material, for example cobalt, nickel or iron and may also, or in place of, include one or more other non-super hard phase additions.

PCT application publication number WO2008/096314 discloses a method of coating diamond particles, to enable the formation of polycrystalline super hard abrasive elements or composites, including polycrystalline super hard abrasive elements comprising diamond in a matrix of material(s) comprising one or more of VN, VC, HfC, NbC, TaC, Mo₂C, WC. PCT application publication number WO2011/141898 also discloses PCD and methods of forming PCD containing additions such as vanadium carbide to improve, inter alia, wear resistance.

Whilst wishing not to be bound by any particular theory, the combination of metal additives within the filler material may be considered to have the effect of better dispersing the energy of cracks arising and propagating within the PCD material in use, resulting in altered wear behaviour of the PCD material and enhanced resistance to impact and fracture, and consequently extended working life in some applications.

The grains of superhard material may be, for example, diamond grains or particles. In the starting mixture prior to sintering they may be, for example, bimodal, that is, the feed comprises a mixture of a coarse fraction of diamond grains and a fine fraction of diamond grains. In some embodiments, the coarse fraction may have, for example, an average particle/grain size ranging from about 10 to 60 microns. By “average particle or grain size” it is meant that the individual particles/grains have a range of sizes with the mean particle/grain size representing the “average”. The average particle/grain size of the fine fraction is less than the size of the coarse fraction. For example, the fine fraction may have an average grain size of between around 1/10 to 6/10 of the size of the coarse fraction, and may, in some embodiments, range for example between about 0.1 to 20 microns.

In some examples, the weight ratio of the coarse diamond fraction to the fine diamond fraction may range from about 50% to about 97% coarse diamond and the weight ratio of the fine diamond fraction may be from about 3% to about 50%. In other embodiments, the weight ratio of the coarse fraction to the fine fraction may range from about 70:30 to about 90:10.

In further examples, the weight ratio of the coarse fraction to the fine fraction may range for example from about 60:40 to about 80:20.

In some examples, the particle size distributions of the coarse and fine fractions do not overlap and in some embodiments the different size components of the compact are separated by an order of magnitude between the separate size fractions making up the multimodal distribution.

Some examples consist of a wide bi-modal size distribution between the coarse and fine fractions of superhard material, but some examples may include three or even four or more size modes which may, for example, be separated in size by an order of magnitude, for example, a blend of particle sizes whose average particle size is 20 microns, 2 microns, 200 nm and 20 nm.

Sizing of diamond particles/grains into fine fraction, coarse fraction, or other sizes in between, may be through known processes such as jet-milling of larger diamond grains and the like.

In some examples, the binder catalyst/solvent may comprise cobalt or some other iron group elements, such as iron or nickel, or an alloy thereof. Carbides, nitrides, borides, and oxides of the metals of Groups IV-VI in the periodic table are other examples of non-diamond material that might be added to the sinter mix. In some examples, the binder/catalyst/sintering aid may be Co.

The cemented metal carbide substrate may be conventional in composition and, thus, may be include any of the Group IVB, VB, or VIB metals, which are pressed and sintered in the presence of a binder of cobalt, nickel or iron, or alloys thereof. In some examples, the metal carbide is tungsten carbide.

FIGS. 3 to 14 are schematic cross-sections through examples of superhard constructions 1.

In a first example, as shown in FIG. 3, the superhard construction 30 includes a layer of superhard material 34 forming the rake face or cutting surface 4 and having the cutting edge 6, a substrate 32 and a region 36 intermediate the layer of superhard material 34 and the substrate 32. The interface 37 between the substrate and the intermediate region 36 being substantially non-planar and the interface 38 between the intermediate region 36 and the layer of superhard material 34 also being substantially non-planar. The intermediate region 36 in the example of FIG. 3 may be, for example, a ceramic material having a fracture toughness of between around 4 MPa√m to around 15 MPa√m, or for example a material comprising a refractory metal, the material forming the intermediate region 36 being and more acid resistant than polycrystalline diamond material having a cobalt binder-catalyst phase, and/or cemented carbide material. In the example of FIG. 3, the intermediate region 36 does not form part of the working surface but is spaced therefrom by a region of the superhard material. Additionally, the intermediate region 36 extends across the interface 37 with the substrate 32 and spaces the superhard layer 34 from the substrate 32.

The example of a superhard construction 40 shown in FIG. 4 differs from that shown in FIG. 3 in that the interface 48 between the layer of superhard material 44 and the substrate 42 is substantially planar, whilst the interface 47 between the substrate 42 and the intermediate region 46 is substantially non-planar as in FIG. 3. The intermediate region 46 may be, for example, a ceramic material having a fracture toughness of between around 4 MPa√m to around 15 MPa√m, or for example a material comprising a refractory metal, the material forming the intermediate region 36 being more acid resistant than polycrystalline diamond material having a (cobalt) binder-catalyst phase, and/or cemented carbide material.

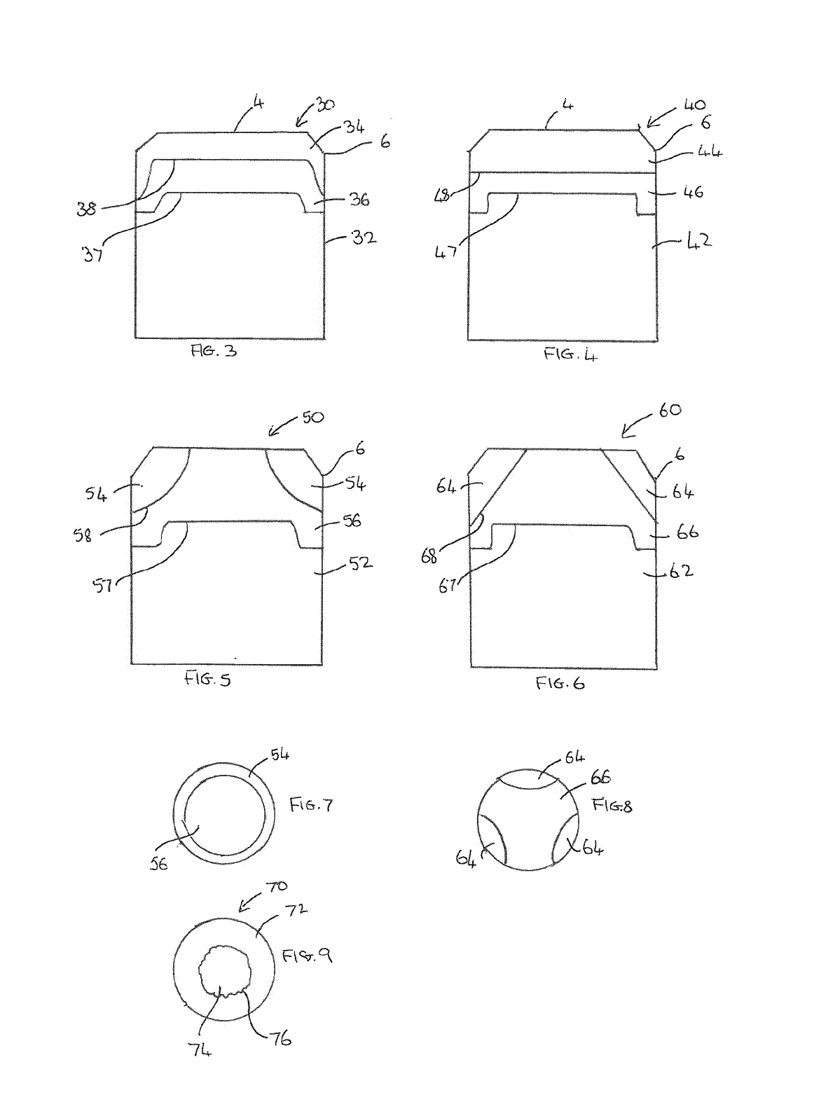

In the example of a superhard construction 50 of FIG. 5, an intermediate region 56 of, for example, a ceramic material having a fracture toughness of between around 4 MPa√m to around 15 MPa√m or a material comprising a refractory metal, and more acid resistant than polycrystalline diamond material having a binder-catalyst phase such as a cobalt binder phase, and/or cemented carbide material is interposed between a substrate 52 and layer of superhard material 54. The intermediate region 56 extends to and forms part of the working surface 4 of the superhard construction 50. As shown in the plan view in FIG. 6, the superhard layer forms an annular portion around the outer peripheral surface of the intermediate region of ceramic material 56. The interface 57 between the intermediate region 56 and the substrate 52 is substantially non-planar and the interface 58 between the intermediate region 56 and the layer of superhard material 54 is also substantially non-planar, the interface being concavely arcuate.

The example of superhard construction 60 shown in FIG. 7 differs from that of FIG. 5 in that the interface 68 between the layer of superhard material 64 and the intermediate region 66 is sloped rather than concavely curved, that is shown by the inclined plane depicted in in cross section in FIG. 7, the intermediate region 66 thereby comprising a truncated cone projecting from the substrate and extending through the layer of superhard material 64 to the cutting face 4. In the example of FIG. 7, the intermediate region 66 may be, for example, a ceramic material having a fracture toughness of between around 4 MPa√m to around 15 MPa√m, or for example a material comprising a refractory metal, the material forming the intermediate region 36 being and more acid resistant than polycrystalline diamond material having a cobalt binder-catalyst phase, and/or cemented carbide material.

The intermediate region 66 is interposed between the substrate 62 and layer of superhard material 64. The intermediate region 66 extends to and forms part of the working surface 4 of the superhard construction 60. As shown in the plan view in FIGS. 6 and 8, the superhard layer may form an annular portion around the outer peripheral surface of the intermediate region 66 or the layer of superhard material 64 may be in the form of segments interposed around the cutting edge with the intermediate region 64. The interface 67 between the intermediate region 66 and the substrate 62 may be substantially non-planar, as shown in FIG. 7 or may be substantially planar. The advantage of such a construction may be that the construction is rotatable after use such that a different cutting edge may be presented to the surface to be cut and also the segments may act to confine damage to a limited area of the construction during use.

In some examples, such as that shown in FIG. 9, and in particular those where the intermediate region extends to and forms part of the cutting face 4, the interface between the intermediate region and the layer of superhard material may be ridge or grooved, such ridges or grooves extending, for example, from the cutting face 4 to the flank face of the construction.

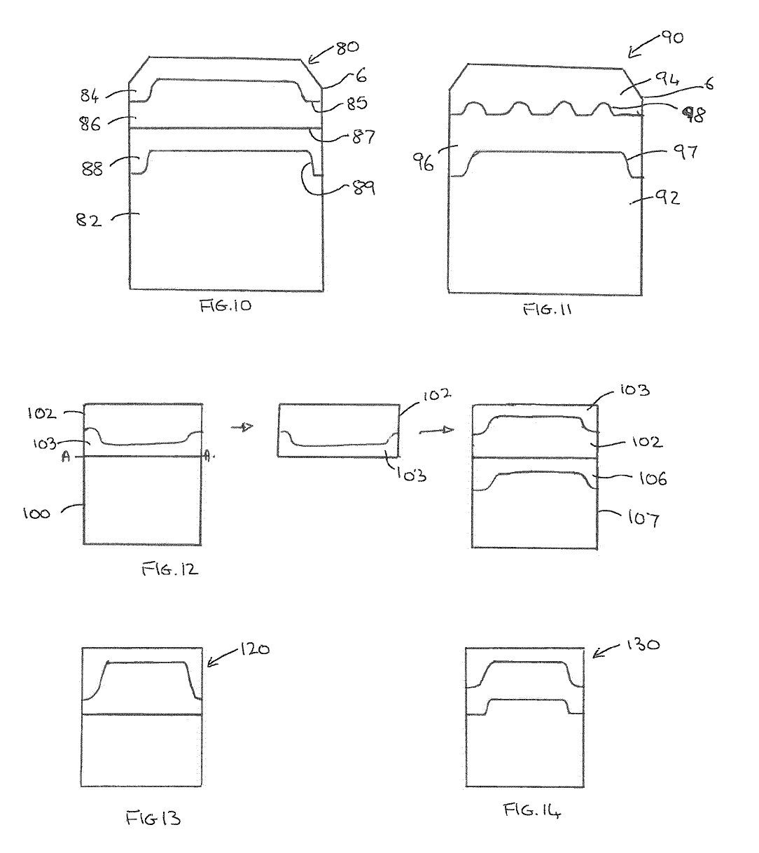

In the example of a superhard construction 80 shown in FIG. 10, the construction comprises a substrate 82 spaced from a layer of superhard material 84 by a first intermediate region 86 and a second intermediate region 88. In the illustrated example, the interface 89 between the substrate 82 and the second intermediate region is substantially non-planar, the interface 87 between the first and second intermediate regions 86 and 88 is substantially planar and the interface 85 between the first intermediate region 86 and the layer of superhard material 84 is substantially non-planar. One or other or both of the first and second intermediate regions 86 and 88 may be, for example, a ceramic material having a fracture toughness of between around 4 MPa√m to around 15 MPa√m, or for example a material comprising a refractory metal, the material forming the intermediate region 36 being and more acid resistant than polycrystalline diamond material having a cobalt binder-catalyst phase, and/or cemented carbide material, or a cermet material which may comprise at least one transition metal. The second intermediate region may, for example, comprise a material having a TRS of around 200 MPa or more.

Whilst not wishing to be bound by a particular theory, it is believed that having a second intermediate region 88 adjacent the substrate 82 may eliminate the sudden change in CTE between the substrate 82 and the first intermediate region 86 and thereby assist in inhibiting cracking and/or delamination of the sintered superhard layer 84 from the substrate by minimising residual stress between layers of different compositions.

In the example shown in FIG. 11, the superhard construction 90 comprises a substrate 92, a layer of superhard material 94 and an intermediate region 96 between the layer of superhard material 94 and the substrate 92 spacing the layer of superhard material 94 from the substrate 92. The interface 97 between the substrate and the intermediate region 96 is substantially non-planar in the illustrated example and the interface 98 between the intermediate region 96 and the layer of superhard material 94 is also substantially non-planar, and may comprise one or more grooves or ridges to provide an interlocking fit between the two layers.

In some examples, such as in any one or more of the examples illustrated in FIGS. 3 to 11, the material in the intermediate region 36, 46, 56, 66, 86, 96 may, for example, have a fracture toughness of between around 6 MPa√m to around 10 MPa√m. In some examples, the material of the intermediate region 36, 46, 56, 66, 86, 96 may, for example, have a TRS of between around 800 MPa to around 2500 MPa, and in some examples, the TRS may be between around 1000 MPa to around 2500 MPa.

In one or more examples, the intermediate region 36, 46, 56, 66, 86, 96 may, for example, have a metal content of around 10 wt % or less, or around 5 wt % or less, or around 4 wt % or less, or around 3 wt % or less, or around 1 wt % or less, whereas in other examples, the intermediate region 36, 46, 56, 66, 86, 96 may, for example, have a substantially no metal content.

In the superhard polycrystalline constructions according to any one or more of the examples, the layer of superhard material 34, 44, 54, 64, 72, 84, 94 comprises a thermally stable material such as thermally stable PCD, and may have a diamond content between around 95 volume % to around 100 volume %. The thermally stable layer of superhard material may, for example, be substantially free of a catalyst material for diamond, said region forming the thermally stable first region, and may, for example comprise at most around 2 weight percent of catalyst material for diamond.

In some examples, the thermally stable layer of superhard material comprises binderless PCD material and/or CVD diamond and/or a polycrystalline super hard material formed from nanodiamond grains.

In some examples, the material forming the intermediate region 36, 46, 56, 66, 74, 86, 96 may comprise a cermet material and/or any one or more of PcBN, a metal superalloy, a silicon nitride based material, a zirconia based material, silicon nitride, silicon carbide, aluminium oxide, titanium carbide, titanium nitride, titanium boride, tungsten carbide, titanium boride, aluminium nitride, aluminium boride, a titanium superalloy. In some examples, the material forming the intermediate region 36, 46, 56, 66, 74, 86, 96 may comprise a refractory metal comprising, for example, any one or more of niobium, molybdenum, tantalum, tungsten, rhenium, titanium, vanadium, chromium, zirconium, hafnium, ruthenium, osmium and iridium or an alloy thereof. In some examples, the material forming the intermediate region 36, 46, 56, 66, 74, 86, 96 may comprise any one or more of an oxide, a nitride, a carbide, a carbonitride, and/or an oxycarbide of any one or more of tantalum, titanium, zirconium, hafnium, vanadium, niobium, molybdenum, tungsten, chromium, rhenium, manganese, copper.

In any one or more examples, the superhard construction has a longitudinal axis, and the thickness of the intermediate region 36, 46, 56, 66, 86, 96 along a plane parallel to the longitudinal axis may, for example, be between around 1 mm to around 6.5 mm, and the intermediate region 36, 46, 56, 66, 86, 96 may be bonded to the layer of superhard material and/or to the second intermediate region 88, and/or to the substrate 32, 42, 52, 62, 82, 92 by a brazed joint and/or a sintered joint along the respective interfaces.

The grains of superhard material used for making the thermally stable superhard layer 34, 44, 54, 64, 84, 94 may be, for example, diamond grains or particles, or for example, cBN grains or particles. In the starting mixture prior to sintering they may be, for example, bimodal, that is, the feed comprises a mixture of a coarse fraction of superhard grains and a fine fraction of superhard grains. In some embodiments, the coarse fraction may have, for example, an average particle/grain size ranging from about 10 to 60 microns. By “average particle or grain size” it is meant that the individual particles/grains have a range of sizes with the mean particle/grain size representing the “average”. The average particle/grain size of the fine fraction is less than the size of the coarse fraction, for example between around 1/10 to 6/10 of the size of the coarse fraction, and may, in some embodiments, range for example between about 0.1 to 20 microns.

In some examples, the weight ratio of the coarse fraction to the fine fraction ranges from about 50% to about 97% coarse superhard grains and the weight ratio of the fine fraction may be from about 3% to about 50%. In other examples, the weight ratio of the coarse fraction to the fine fraction will range from about 70:30 to about 90:10.

In further examples, the weight ratio of the coarse fraction to the fine fraction may range for example from about 60:40 to about 80:20.

In some examples, the particle size distributions of the coarse and fine fractions do not overlap and in some embodiments the different size components of the compact are separated by an order of magnitude between the separate size fractions making up the multimodal distribution.

Some examples consist of a wide bi-modal size distribution between the coarse and fine fractions of superhard material, but some examples may include three or even four or more size modes which may, for example, be separated in size by an order of magnitude, for example, a blend of particle sizes whose average particle size is 20 microns, 2 microns, 200 nm and 20 nm.

Sizing of diamond particles/grains into fine fraction, coarse fraction, or other sizes in between, may be through known processes such as jet-milling of larger diamond grains and the like.

In examples where the superhard material is polycrystalline diamond material, the diamond grains used to form the polycrystalline diamond material may be natural or synthetic.

In some examples, the polycrystalline superhard material is PCBN and the superhard particles or grains comprise cBN.

In some examples, the binder catalyst/solvent used to assist in the bonding of the grains of superhard material such as diamond grains, may comprise cobalt or some other iron group elements, such as iron or nickel, or an alloy thereof. Carbides, nitrides, borides, and oxides of the metals of Groups IV-VI in the periodic table are other examples of non-diamond material that might be added to the sinter mix. In some examples, the binder/catalyst/sintering aid may be Co.

The cemented metal carbide substrate may be conventional in composition and, thus, may be include any of the Group IVB, VB, or VIB metals, which are pressed and sintered in the presence of a binder of cobalt, nickel or iron, or alloys thereof. In some examples, the metal carbide is tungsten carbide.

The superhard constructions of the examples may be fabricated, for example, as follows.

As used herein, a “green body” is a body comprising grains to be sintered and a means of holding the grains together, such as a binder, for example an organic binder.

Examples of superhard constructions may be made by a method of preparing a green body comprising grains or particles of superhard material, non-reactive phase and a binder, such as an organic binder. The green body may also comprise catalyst material for promoting the sintering of the superhard grains. The green body may be made by combining the grains or particles with the binder/catalyst and forming them into a body having substantially the same general shape as that of the intended sintered body, and drying the binder. At least some of the binder material may be removed by, for example, burning it off. The green body may be formed by a method including a compaction process, an injection process or other methods such as molding, extrusion, deposition modelling methods.

The substrate and intermediate region(s) are preferably pre-formed. In some examples, the substrate may be pre-formed by pressing the green body of grains of hard material such as tungsten carbide into the desired shape, including the interface features at one free end thereof, and sintering the green body to form the substrate element. In an alternative example, the substrate interface features may be machined from a sintered cylindrical body of hard material, to form the desired geometry for the interface features. The substrate may, for example, comprise WC particles bonded with a catalyst material such as cobalt, nickel, or iron, or mixtures thereof. A green body for the superhard construction, which comprises the pre-formed substrate and the particles of superhard material such as diamond particles or cubic boron nitride particles, may be placed onto the substrate, to form a pre-sinter assembly which may be encapsulated in a capsule for an ultra-high pressure furnace, as is known in the art. In particular, the superabrasive particles, for example in powder form, are placed inside a metal cup formed, for example, of niobium, tantalum, or titanium. The pre-formed substrate and intermediate region(s) are placed inside the cup and hydrostatically pressed into the superhard powder such that the requisite powder mass is pressed around the interface features of the preformed carbide substrate to form the pre-composite. The pre-composite is then outgassed at about 1050 degrees C. The pre-composite is closed by placing a second cup at the other end and the pre-composite is sealed by cold isostatic pressing or EB welding. The pre-composite is then sintered to form the sintered body of superhard material bonded to the substrate along the interface therewith.

In some examples, the superhard grains may be diamond grains and the substrate may be cobalt-cemented tungsten carbide, the cobalt in the substrate being a source of catalyst for sintering the diamond grains. The pre-sinter assembly may comprise an additional source of catalyst material.

In one example, the method may include loading the capsule comprising a pre-sinter assembly into a press and subjecting the green body to an ultra-high pressure and a temperature at which the superhard material is thermodynamically stable to sinter the superhard grains. In some examples, the green body may comprise diamond grains and the pressure to which the assembly is subjected is at least about 5 GPa and the temperature is at least about 1,300 degrees centigrade. In some examples, the pressure to which the assembly may be subjected is around 5.5-6 GPa, but in some examples it may be around 7.7 GPa or greater. Also, in some examples, the temperature used in the sintering process may be in the range of around 1400 to around 1500 degrees C.

A version of the method may include making a diamond composite structure by means of a method disclosed, for example, in PCT application publication number WO2009/128034 with the additional step of admixing with the diamond grains, prior to sintering, catalyst material in the form of a metal binder such as 0 to 3 wt % cobalt. A powder blend comprising diamond particles and the metal binder material, such as cobalt may be prepared by combining these particles and blending them together. An effective powder preparation technology may be used to blend the powders, such as wet or dry multi-directional mixing, planetary ball milling and high shear mixing with a homogenizer. In one example, the mean size of the diamond particles may be from about 1 to at least about 50 microns and they may be combined with other particles by mixing the powders or, in some cases, stirring the powders together by hand. In one version of the method, precursor materials suitable for subsequent conversion into binder material may be included in the powder blend, and in one version of the method, metal binder material may be introduced in a form suitable for infiltration into a green body. The powder blend may be deposited in a die or mold and compacted to form a green body, for example by uni-axial compaction or other compaction method, such as cold isostatic pressing (CIP). The green body may be subjected to a sintering process known in the art to form a sintered article. In one version, the method may include loading the capsule comprising a pre-sinter assembly into a press and subjecting the green body to an ultra-high pressure and a temperature at which the superhard material is thermodynamically stable to sinter the superhard grains.

After sintering, the polycrystalline super hard constructions may be ground to size and may include, if desired, a 45° chamfer of approximately 0.4 mm height on the body of polycrystalline super hard material so produced.

In the example of PCD, the sintered article may be subjected to a subsequent treatment at a pressure and temperature at which diamond is thermally stable to convert some or all of the non-diamond carbon back into diamond and produce a diamond composite structure. An ultra-high pressure furnace well known in the art of diamond synthesis may be used and the pressure may be at least about 5.5 GPa and the temperature may be at least about 1,250 degrees centigrade for the second sintering process.

Solvent/catalyst for diamond may be introduced into the aggregated mass of diamond grains by various methods, including blending solvent/catalyst material in powder form with the diamond grains, depositing solvent/catalyst material onto surfaces of the diamond grains, or infiltrating solvent/catalyst material into the aggregated mass from a source of the material other than the substrate, either prior to the sintering step or as part of the sintering step. Methods of depositing solvent/catalyst for diamond, such as cobalt, onto surfaces of diamond grains are well known in the art, and include chemical vapour deposition (CVD), physical vapour deposition (PVD), sputter coating, electrochemical methods, electroless coating methods and atomic layer deposition (ALD). It will be appreciated that the advantages and disadvantages of each depend on the nature of the sintering aid material and coating structure to be deposited, and on characteristics of the grain.

In one example, the binder/catalyst such as cobalt may be deposited onto surfaces of the diamond grains by first depositing a pre-cursor material and then converting the precursor material to a material that comprises elemental metallic cobalt. For example, in the first step cobalt carbonate may be deposited on the diamond grain surfaces using the following reaction:

Co(NO₃)₂+Na₂CO₃->CoCO₃+2NaNO₃

The deposition of the carbonate or other precursor for cobalt or other solvent/catalyst for diamond may be achieved by means of a method described in PCT patent publication number WO/2006/032982. The cobalt carbonate may then be converted into cobalt and water, for example, by means of pyrolysis reactions such as the following:

CoCO₃->COO+CO₂

CoO+H₂->Co+H₂O

In another example, cobalt powder or precursor to cobalt, such as cobalt carbonate, may be blended with the diamond grains. Where a precursor to a solvent/catalyst such as cobalt is used, it may be necessary to heat treat the material in order to effect a reaction to produce the solvent/catalyst material in elemental form before sintering the aggregated mass.

In some examples, the cemented carbide substrate may be formed of tungsten carbide particles bonded together by the binder material, the binder material comprising an alloy of Co, Ni and Cr. The tungsten carbide particles may form at least 70 weight percent and at most 95 weight percent of the substrate. The binder material may comprise between about 10 to 50 wt. % Ni, between about 0.1 to 10 wt. % Cr, and the remainder weight percent comprises Co.

Examples are described in more detail below with reference to the following which are provided herein by way of illustration only and are not intended to be limiting.

### Example 1

The superhard constructions of FIGS. 3, 4 and 11 may be formed as follows.

A cobalt disc (200 microns in thickness) is placed at the bottom of a Nb cup. About 2 grams of diamond powder with an average grain size of 20 micron is loaded into the cup. A pre-formed body of ceramic material comprising around 99.7% aluminium oxide is inserted into the diamond powder. The pre-formed ceramic has a projection extending to about 1 mm from the end surface of the diamond grains. A pre-formed cemented carbide substrate comprising around 13% Co is placed adjacent the pre-formed ceramic material in the cup. The assembly is double cupped using Ti caps and outgassed at 1100° C., for about 30 minutes. The unit is sealed and sintered at a pressure of around 5.7 GPa and a temperatrue of around 1450° C. for at least 30 seconds to form a PCD construction. The PCD construction is recovered after sintering and fully processed to a diamond table thickness close to around 2.5 mm (from the cutting surface to the interface with the intermediate region of ceramic material) and a diameter of around 16.00 mm with an overall height of around 13.00 mm (including the substrate).

The PCD construction is then subjected to a post sintering treatment such as acid leaching to remove residual binder from interstices between the superhard grains forming the polycrystalline diamond layer. The material of the intermediate region is more resistant to acid damage than either PCD containing interstitial Co and/or that cemented WC, and the superhard construction 30, 40, 90 comprises a substrate 32, 42, 92 that has been protected during the leaching process either by a seal or masking or other form of barrier protection from the acid, and a thermally stable layer of superhard material 34, 44, 94 separated from the substrate 32, 42, 92 by the intermediate region 36, 46, 96. The acid resistance of the material of the intermediate region being more acid resistant than PCD containing interstitial cobalt and/or WC may be determined by whether or not it is more resistant to acid damage after 30 hours in a mixture of boiling HCl and water where the HCl forms 20% and the water the residual 80% of the acid leaching mixture, and confirming that the material of the intermediate region shows less than a 10% reduction in its starting weight.

### Example 2

The superhard constructions of FIGS. 5 to 9 may be formed as follows.

A cobalt disc containing around 5 wt % Fe with a thickness close to around 300 microns is placed at the bottom of a Ta cup. About 1.5 grams of diamond powder with an average grain size of about 10 microns, is then loaded into the cup. A pre-formed body of ceramic material comprising around 99.7% aluminium oxide is inserted into the diamond powder. A pre-formed cemented carbide substrate having the desired interface as shown in the examples of FIGS. 5 to 9 comprising around 13% Co is placed adjacent the body of ceramic material. The assembly is double cupped using steel cans and vacuum outgassed at around 1100° C., for about 30 minutes and sealed. The assembly is placed into a high temperature and high pressure apparatus and sintered at a pressure of around 8.0 GPa and temperature of around 1450° C. for at least 30 seconds to form a sintered PCD construction. The sintered PCD construction is recovered and fully processed to a diamond table thickness of around 2.5 mm, and a diameter of around 16 mm, the superhard construction having an overall height including the substrate of around 13 mm. The body of ceramic material, as shown in FIGS. 5 to 9 extends to and forms part of the working surface of the construction and may, for example have an axial thickness of around 3 mm.

The PCD construction is then subjected to a post sintering treatment such as acid leaching to remove residual binder from interstices between the superhard grains forming the polycrystalline diamond layer. The material of the intermediate region is more resistant to acid damage than either PCD containing interstitial Co and/or that cemented WC, and the superhard construction 50, 60, 70 comprises a substrate 52, 62, that has been protected during the leaching process either by a seal or masking or other form of barrier protection from the acid, and a thermally stable layer of superhard material 54, 64, 72 separated from the substrate 52, 62 by the intermediate region 56, 66, 74. The acid resistance of the material of the intermediate region being more acid resistant than PCD containing interstitial cobalt and/or WC may be determined by whether or not it is more resistant to acid damage after 30 hours in a mixture of boiling HCl and water where the HCl forms 20% and the water the residual 80% of the acid leaching mixture, and confirming that the material of the intermediate region shows less than a 10% reduction in its starting weight.

### Example 3

The superhard construction of FIG. 10 may be formed as follows.

A cobalt disc (having a thickness of around 200 microns) is placed at the bottom of a Nb cup. About 1.8 grams of diamond powder with an average grain size of around 6 microns is loaded into the cup. A pre-formed body of ceramic material comprising around 99.7% Aluminium Oxide is inserted into the diamond powder. The pre-formed body of ceramic material has a projection extending to about 1.2 mm from the end of the diamond powder. A pre-formed disc comprising TiC—NiMo having a thickness of around 50 microns is placed adjacent the body of ceramic material and a pre-formed substrate comprising cemented carbide such as WC and around 13 wt % Co is placed on the cermet disc in the cup. The assembly is double cupped and vacuum outgassed at around 1100° C., for about 30 minutes and sealed. The assembly is placed into a high temperature and high pressure apparatus and sintered at around 7.5 GPa and around 1450° C. for at least 30 seconds to form a sintered PCD construction. The sintered PCD construction is recovered, processed and analysed. The PCD construction may be finished to have a diamond layer thickness of around 2.2 mm, a diameter of around 16 mm and an overall height (including the substrate of around 12 mm).

The body of ceramic material, as shown in FIG. 10 is spaced from the working surface of the construction, for example by up to around 1 mm, and may, for example have an axial thickness of around 3 mm.

The PCD construction is then subjected to a post sintering treatment such as acid leaching to remove residual binder from interstices between the superhard grains forming the polycrystalline diamond layer. The material of the intermediate region is more resistant to acid damage than either PCD containing interstitial Co and/or that cemented WC, and the superhard construction 80 comprises a substrate 82 that has been protected during the leaching process either by a seal or masking or other form of barrier protection from the acid, and a thermally stable layer of superhard material 84 separated from the substrate 82 by the intermediate region 86 and the intermediate cermet region 88. The acid resistance of the material of the intermediate region being more acid resistant than PCD containing interstitial cobalt and/or WC may be determined by whether or not it is more resistant to acid damage after 30 hours in a mixture of boiling HCl and water where the HCl forms 20% and the water the residual 80% of the acid leaching mixture, and confirming that the material of the intermediate region shows less than a 10% reduction in its starting weight.

The TiC—NiMo disc may assist in improving the adhesion between the cemented carbide substrate and the body of ceramic material.

### Example 4

The superhard constructions of FIGS. 3, 4 and 11 may alternatively be formed as follows.

A disc (3 mm in thickness) formed of cemented carbide comprising around 13 wt % Co is placed at the bottom of a Nb cup. About 1.8 grams of diamond powder with an average grain size of around 15 microns is loaded into the cup. A pre-formed body of silicon carbide ceramic material is inserted into the diamond powder. The pre-formed SiC ceramic material has a projection extending to about 1 mm from the end surface of the diamond grains. A pre-formed cemented carbide substrate containing around 11% Co is placed adjacent the body of ceramic material. The assembly is double cupped and vacuum outgassed at around 1100° C., for about 30 minutes and sealed. The assembly is placed into a high temperature and high pressure apparatus and sintered at around 7.2 GPa and around 1450° C. for at least 30 seconds to form the sintered PCD construction. The sintered PCD construction is then recovered, processed and analysed. The PCD construction may be finished to have a diamond layer thickness of, for example, around 2.5 mm and a diameter of for example around 16 mm and an overall height including the substrate of around 13 mm.

The PCD construction is then subjected to a post sintering treatment such as acid leaching to remove residual binder from interstices between the superhard grains forming the polycrystalline diamond layer. The material of the intermediate region is more resistant to acid damage than either PCD containing interstitial Co and/or that cemented WC, and the superhard construction 30, 40, 90 comprises a substrate 32, 42, 92 that has been protected during the leaching process either by a seal or masking or other form of barrier protection from the acid, and a thermally stable layer of superhard material 34, 44, 94 separated from the substrate 32, 42, 92 by the intermediate region 36, 46, 96. The acid resistance of the material of the intermediate region being more acid resistant than PCD containing interstitial cobalt and/or WC may be determined by whether or not it is more resistant to acid damage after 30 hours in a mixture of boiling HCl and water where the HCl forms 20% and the water the residual 80% of the acid leaching mixture, and confirming that the material of the intermediate region shows less than a 10% reduction in its starting weight.

### Example 5

The superhard constructions of FIGS. 5 to 9 may alternatively be formed as follows.

A 300 micron thick Co disc containing around 5 wt % Fe is placed at bottom of a Nb cup. Around 1.5 grams of diamond powder with an average grain size of around 25 microns is loaded into the cup. A pre-formed alumina disc comprising around 99.7 wt % Aluminium oxide having a diameter of around 9 mm and a height of around 1.5 mm is placed in the centre and on top of the diamond powder. Around 3 grams of Alumina powder is then placed on top of the Aluminium oxide disc. A pre-formed cemented WC substrate comprising around 13 wt % Co is placed adjacent the alumina disc. The assembly is double cupped and vacuum outgassed at around 1100° C., for about 30 minutes and sealed. The assembly is placed into a high temperature and high pressure apparatus and sintered at around 6.5 GPa and around 1450° C. for at least 30 seconds to form the sintered PCD construction. The sintered PCD construction is recovered, processed and analysed. The PCD construction is finished to have a diamond layer thickness of around 2.5 mm, measuring from the cutting surface to the interface with the substrate along the peripheral side edge of the cutter. The Alumina ceramic region is exposed through and forms part of the working surface at the centre of the PCD construction.

The PCD construction is then subjected to a post sintering treatment such as acid leaching to remove residual binder from interstices between the superhard grains forming the polycrystalline diamond layer. The material of the intermediate region is more resistant to acid damage than either PCD containing interstitial Co and/or that cemented WC, and the superhard construction 50, 60, 70 comprises a substrate 52, 62, that has been protected during the leaching process either by a seal or masking or other form of barrier protection from the acid, and a thermally stable layer of superhard material 54, 64, 72 separated from the substrate 52, 62 by the intermediate region 56, 66, 74. The acid resistance of the material of the intermediate region being more acid resistant than PCD containing interstitial cobalt and/or WC may be determined by whether or not it is more resistant to acid damage after 30 hours in a mixture of boiling HCl and water where the HCl forms 20% and the water the residual 80% of the acid leaching mixture, and confirming that the material of the intermediate region shows less than a 10% reduction in its starting weight.

### Example 6

The superhard constructions of FIGS. 5 to 9 may alternatively be formed as follows.

A cobalt disc comprising around 5 wt % Fe (having a thickness of around 300 microns) is placed at bottom of a Nb cup. About 1.8 grams of diamond powder with an average grain size of around 12 microns is loaded into the cup. A pre-formed alumina ceramic disc comprising around 70 wt % Alumina and around 30 wt % TiC and having a diameter of around 9 mm and thickness of around 1.5 mm is placed in the centre and on top of the diamond powder. Around 1.5 grams of powder mixture comprising around 90 wt % Alumina powder with 99.9% purity and around 10 wt % diamond powder having an average particle size of around 30 microns is placed in the cup over the Alumina-TiC disc. A cemented carbide substrate having around 13 wt % Co is placed adjacent the alumina-diamond powder mixture in the cup. The assembly is double cupped and vacuum outgassed at around 1100° C., for about 30 minutes and sealed. The assembly is placed into a high temperature and high pressure apparatus and sintered at around 6.0 GPa and around 1450° C. for at least 30 seconds to form a sintered PCD construction. The sintered PCD construction is recovered, processed and analysed. The PCD construction is finished to have, for example, a PCD thickness of around 2.5 mm measured from the working surface to the interface with the substrate along the peripheral side edge of the construction. The alumina ceramic region is exposed through and forms part of the working surface of the construction. The overall diameter of the cutter may be around 16 mm and height around 13 mm.

The PCD construction is then subjected to a post sintering treatment such as acid leaching to remove residual binder from interstices between the superhard grains forming the polycrystalline diamond layer. The material of the intermediate region is more resistant to acid damage than either PCD containing interstitial Co and/or that cemented WC, and the superhard construction 50, 60, 70 comprises a substrate 52, 62, that has been protected during the leaching process either by a seal or masking or other form of barrier protection from the acid, a thermally stable layer of superhard material 54, 64, 72 separated from the substrate 52, 62 by the intermediate region 56, 66, 74. The acid resistance of the material of the intermediate region being more acid resistant than PCD containing interstitial cobalt and/or WC may be determined by whether or not it is more resistant to acid damage after 30 hours in a mixture of boiling HCl and water where the HCl forms 20% and the water the residual 80% of the acid leaching mixture, and confirming that the material of the intermediate region shows less than a 10% reduction in its starting weight.

In a further example, such as that shown in FIG. 12, The order into which the components are loaded into the cup prior to sintering of the final construction may be changed such that initially, the pre-formed material 102 for the intermediate region may be placed in the cup and the diamond grains 103 may be placed thereon followed by a pre-formed cemented carbide substrate 100. The assembly is then sintered as described in the above examples to form an initial PCD construction. The substrate 100 may be removed from the sintered PCD layer 103, along the line A-A, by EDM or laser techniques, for example, and the PCD layer 102 and intermediate region 103 may be subjected to a treatment process such as acid leaching to remove the residual catalyst binder from the interstices of the PCD material and render it thermally stable. The TS PCD 103 with the intermediate region 102 bonded thereto may then be reattached to a new substrate 107 either directly (as shown in FIG. 13 where there is a substantially planar interface between the substrate and the intermediate region or as shown in FIG. 14 where there is a substantially non-planar interface between the substrate and the intermediate region) or through a further intermediate layer 106 which may, for example, be formed of a cermet material as described above with respect to FIG. 10. This may, for example be achieved by brazing.

In alterative examples, the pre-formed intermediate region may be bonded to the pre-formed substrate at a high pressure using a hot press at around 100 MPa to around 200 MPa and temperature of around 1500 degrees C. The assembly may then be brazed to a fully leached PCD table at a temperature of around 900 degrees C. using for example a Ticusil™ braze paste under a vacuum. The construction may then be processed to the required final dimensions.

Whilst not wishing to be bound by a particular theory, it is believed that in the examples where the one or more intermediate regions is/are formed of a material which has a toughness and/or strength comparable to that of unleached PCD, the intermediate region(s) provide(s) a good support to the TS superhard layer, particularly as, for example, it is known that leaching conventional PCD typically reduces the strength of the PCD by up to around 30%. The intermediate region(s) may be shaped to suit the particular end application of the superhard construction, for example, to ensure that a large surface area of TS superhard material may be presented at the cutting edge so that as the wear scar progresses, the wear is contained in the TS region which is supported by a tough and strong ceramic supporting intermediate region. The protrusion in the intermediate region may have a higher impact resistance compared to the superhard layer and thereby act to assist in arresting cracks to avoid spalling or catastrophic failure during use of the superhard construction.

The size and shape of the intermediate region(s) and the TS superhard layer may be tailored to the final application of the superhard material. It is believed possible to improve spalling resistance without significantly compromising the overall abrasion resistance of the material, which is desirable for PCD and PCBN cutting tools.

Observation of the wear scar development during testing showed the material's ability to generate large wear scars without exhibiting brittle-type micro-fractures (e.g. spalling or chipping), leading to a longer tool life.

Thus, examples of, for example, a PCD material, may be formed having a combination of high abrasion and fracture performance.

The superhard constructions may be finished by, for example, grinding, to provide a PCD element which is substantially cylindrical and having a substantially planar working surface, or a generally domed, pointed, rounded conical or frusto-conical working surface. The PCD element may be suitable for use in, for example, a rotary shear (or drag) bit for boring into the earth, for a percussion drill bit or for a pick for mining or asphalt degradation.

While various versions have been described with reference to a number of examples, those skilled in the art will understand that various changes may be made and equivalents may be substituted for elements thereof and that these examples are not intended to limit the particular versions disclosed. For example, to render the PCD thermally stable, the PCD structure with the intermediate region attached may be subjected to acid to leach out catalyst material from between the diamond grains, or to other methods of achieving this, such as electrochemical methods.

1. A superhard polycrystalline construction comprising:
a first region comprising a body of thermally stable polycrystalline superhard material having an exposed surface forming a working surface, and a peripheral side edge;
a second region forming a substrate to the first region; and
a third region at least partially interposed between the first and second regions; wherein:
the third region comprises a material more acid resistant than polycrystalline diamond material having a binder-catalyst phase comprising cobalt, and/or more acid resistant than cemented carbide material.

2. The super hard polycrystalline construction as claimed in claim 1, wherein the third region extends to and forms part of the working surface.

3. The superhard polycrystalline construction of any one of the preceding claims, wherein the material of the third region has a fracture toughness of between around 4 MPa√m to around 15 MPa√m.

4. The superhard polycrystalline construction of any one of the preceding claims, wherein the third region has an outer peripheral surface, the first region extending around at least a portion of the peripheral outer surface of the third region.

5. The super hard polycrystalline construction as claimed in any one of the preceding claims, wherein the first region comprises one or more segments located in one or more recesses in the third region.

6. The super hard polycrystalline construction as claimed in any one of the preceding claims, wherein the material of the third region comprises a refractory metal.

7. The super hard polycrystalline construction as claimed in claim 6, wherein the refractory metal comprises any one or more of niobium, molybdenum, tantalum, tungsten, rhenium, titanium, vanadium, chromium, zirconium, hafnium, ruthenium, osmium and iridium or an alloy thereof.

8. The super hard polycrystalline construction as claimed in any one of claims 1 to 5, wherein the material of the third region comprises a cermet material.

9. The super hard polycrystalline construction as claimed in any one of claims 1 to 5, wherein the material of the third region comprises a ceramic material.

10. The super hard polycrystalline construction as claimed in any one of claims 1 to 5 and 9, wherein the material of the third region comprises any one or more of PcBN, a metal superalloy, a silicon nitride based material, a zirconia based material, silicon nitride, silicon carbide, aluminium oxide, titanium carbide, titanium nitride, titanium boride, tungsten carbide, titanium boride, aluminium nitride, aluminium boride, a titanium superalloy.

11. The super hard polycrystalline construction as claimed in any one of claims 1 to 5, wherein the material of the third region comprises any one or more of an oxide, a nitride, a carbide, a carbonitride, and/or an oxycarbide of any one or more of tantalum, titanium, zirconium, hafnium, vanadium, niobium, molybdenum, tungsten, chromium, rhenium, manganese, copper.

12. A superhard polycrystalline construction having an exposed working surface comprising:
a first region comprising a body of thermally stable polycrystalline superhard material having a free external surface forming a portion of the working surface;
a second region forming a substrate to the first region; and
a third region at least partially interposed between the first and second regions; wherein:
the third region comprises a ceramic material having a fracture toughness of between around 4 MPa√m to around 15 MPa√m, the third region extending to and forming a further portion of the working surface.

13. The superhard polycrystalline construction of any one of the preceding claims, wherein the material in the third region has a fracture toughness of between around 6 MPa√m to around 10 MPa√m.

14. The superhard polycrystalline construction of any one of the preceding claims, wherein the material in the third region has a TRS of between around 600 MPa to around 2500 MPa.

15. The superhard polycrystalline construction of any one of the preceding claims, wherein the material in the third region has a TRS of between around 1000 MPa to around 2500 MPa.

16. The superhard polycrystalline construction of any one of the preceding claims, wherein the third region has a metal content of around 10 wt % or less.

17. The superhard polycrystalline construction of any one of the preceding claims, wherein the third region has a metal content of around 4 wt % or less.

18. The superhard polycrystalline construction of any one of the preceding claims, wherein the third region has a metal content of around 5 wt % or less.

19. The superhard polycrystalline construction of any one of the preceding claims, wherein the third region has a metal content of around 3 wt % or less.

20. The superhard polycrystalline construction of any one of the preceding claims, wherein the third region has substantially no metal content.

21. The superhard polycrystalline construction of any one of the preceding claims, wherein the first region has a diamond content between around 95 volume % to around 100 volume %.

22. The super hard polycrystalline construction according to any one of the preceding claims, wherein the first region is substantially free of a catalyst material for diamond, said region forming the thermally stable first region.

23. The super hard polycrystalline construction as claimed in claim 22, wherein the thermally stable first region comprises at most 2 weight percent of catalyst material for diamond.

24. The super hard polycrystalline construction as claimed in any one of the preceding claims, wherein the thermally stable first region comprises binderless PCD material.

25. The super hard polycrystalline construction as claimed in any one of the preceding claims, wherein the thermally stable first region comprises CVD diamond.

26. The super hard polycrystalline construction as claimed in any one of the preceding claims, wherein the thermally stable first region comprises polycrystalline super hard material formed from nanodiamond grains.

27. The super hard polycrystalline construction as claimed in any one of the preceding claims, wherein the first region is bonded to the second region along a first interface, and the second region is bonded to the third region along a second interface, wherein one or other or both of the first or second interfaces is substantially non-planar.

28. The super hard polycrystalline construction as claimed in claim 27, wherein one or other or both of the first or second interfaces has one or more grooves or channels therein or therealong.

29. The super hard polycrystalline construction as claimed in any one of the preceding claims, wherein the construction has a longitudinal axis, the thickness of the third region along a plane parallel to the longitudinal axis is between around 1 mm to around 6.5 mm.

30. The super hard polycrystalline construction as claimed in any one of the preceding claims, wherein the third region is bonded to the first region and/or the second region by a brazed joint and/or a sintered joint along the first and/or second interfaces respectively.

31. The super hard polycrystalline construction as claimed in any one of the preceding claims, further comprising a fourth region interposed at least in part between the third region and the substrate or between the first and the second regions.

32. The super hard polycrystalline construction as claimed in claim 31, wherein the fourth region comprises a cermet material.

33. The super hard polycrystalline construction as claimed in any one of claim 31 or 32, wherein the fourth region comprises at least one transition metal compound.

34. The super hard polycrystalline construction as claimed in any one of claims 31 to 33, wherein the fourth region comprises a material having a TRS of around 200 MPa or more.

35. The super hard polycrystalline construction as claimed in any one of the preceding claims, wherein the third region extends from the substrate towards the working surface, the third region having an outer peripheral surface, the first region extending around the peripheral outer surface of the third region.

36. The super hard polycrystalline construction as claimed in claim 35, wherein the body of polycrystalline superhard material has a thickness from the working surface along the peripheral side edge to the interface with the substrate of at least around 3 mm; and
wherein at least a portion of the third region has a thickness measured in a plane extending along the longitudinal axis of the construction of at least around 3 mm.

37. The superhard polycrystalline construction of claim any one of the preceding claims, wherein the third region extends to and forms part of the working surface.

38. The superhard polycrystalline construction of any one of the preceding claims, wherein the third region extends to a distance of around 0.5 mm or less from the cutting face.

39. The superhard polycrystalline construction of any one of the preceding claims, wherein the body of polycrystalline superhard material comprises natural and/or synthetic diamond grains, and/or cubic boron nitride grains.

40. The superhard polycrystalline construction of any one of the preceding claims, wherein the substrate is formed of cemented carbide material.

41. The superhard polycrystalline construction of claim 40, wherein the cemented carbide substrate comprises tungsten carbide particles bonded together by a binder material.

42. The superhard polycrystalline construction of claim 41, wherein the binder material comprises one or more of Co, Ni and Cr or an alloy thereof.

43. The superhard polycrystalline construction of any one of the preceding claims wherein the depth of the first region thermally stable region from the working surface along the peripheral side edge is at least around 3.5 mm or greater.

44. A superhard polycrystalline construction for a rotary shear bit for boring into the earth, or for a percussion drill bit, comprising the superhard polycrystalline construction as claimed in any one of the preceding claims.

45. A tool comprising a superhard polycrystalline construction according to any one of claims 1 to 43, the tool being for cutting, milling, grinding, drilling, earth boring, rock drilling or another abrasive application.

46. A tool according to claim 45, wherein the tool comprises a drill bit for earth boring or rock drilling.

47. A tool according to claim 45, wherein the tool comprises a rotary fixed-cutter bit for use in oil and gas drilling.

48. A tool according to claim 45, wherein the tool is a rolling cone drill bit, a hole opening tool, an expandable tool, a reamer or other earth boring tool.

49. A drill bit or a cutter or a component therefor comprising the superhard polycrystalline construction according to any one of claims 1 to 43.

50. A superhard polycrystalline construction substantially as hereinbefore described with reference to any one embodiment as that embodiment is illustrated in the accompanying drawings.

51. A method of making a superhard polycrystalline construction, substantially as hereinbefore described with reference to any one embodiment as that embodiment is illustrated in the accompanying drawings.
